(19) United States
(12) Patent Application Publication
(10) Pub. No.: US 2013/0137067 A1
(43) Pub. Date: May 30, 2013

(54) METHOD OF EXPRESSION

(71) Applicant: Robert ST. CROIX, West Palm Beach, FL (US)

(72) Inventor: Robert ST. CROIX, West Palm Beach, FL (US)

(21) Appl. No.: 13/306,294

(22) Filed: Nov. 29, 2011

(51) Int. Cl. B44B 1/00

(52) U.S. Cl. 434/82

(57) ABSTRACT

A method of expression includes exhibiting a sculpture which embodies a living organism. The sculpture has several different components which are representative of parts and processes which are need to support the life and growth of a living organism.

### FIELD OF THE INVENTION

Embodiments are directed to sculptures of electrochemical devices which nurture growth of natural systems. In some aspects, these devices are manufactured to express the key elements of the living system as in nature.

### BACKGROUND

Sculpture is the creation of three-dimensional objects for artistic purposes by the manipulation of materials. The carving of wood, the chiseling of stone, the casting or welding of metal, and the modeling of clay or wax are all examples of sculpting methods. Although wood, stone, metal, clay, and wax are the conventional materials used in sculpture, any material may be used. In addition to using a single material for a sculpture, multiple discrete materials may be used, such as metal-covered plaster.

Sculpture is a means for the artist to communicate a message to the observer. These messages can pertain to the artist's interpretation of the world. The approaches artists use to communicate take a wide variety of forms, ranging from realism to cubism, from impressionism to abstract art, and everything in between. New and different messages and methods of expressing these messages are always evolving.

### SUMMARY

This Summary is provided to present a summary of the invention to briefly indicate the nature and substance of the invention. It is submitted with the understanding that it will not be used to interpret or limit the scope or meaning of the claims.

Embodiments are directed to a method of expression of a living system. In general embodiments, the invention are directed to three dimensional sculptural mechanical devices that can nurture and grow organic life forms, such as flowers. The sculptures or devices comprise components to portray the appearance of independent and self-contained units which have the ability to travel. These components can resemble engines, motors, wheels and the like.

In general embodiments, the devices appear as sculptures and possess an image or expression of an organic component. The organic component can be representative of any organic matter or feature thereof. For example, the organic matter can be any living organism, such as for example, plants, including trees, bushes, branches; birds, reptiles, animals, humans and the like. Examples of features of organic matter can include parts of that organic component, for example, a flower, head of a human or animal, eyes, stems, and the like. In preferred embodiments, the devices or sculptures comprise mechanical and/or electrical and/or chemical features which appear to nurture and protect the organic form. The devices comprise elements or components that give the appearance that they can move about on their own. For example, jet engines, motors, train engines, pulleys, wheels, tracks and the like. In addition the devices are self-contained units. For example, the devices nurture an organic form, provide their own power (e.g. solar arrays or cells) receive communications, move and the like. Further embodiments of the devices comprise one or more satellite dishes, antennas or any device capable of receiving and/or transmitting information.

The devices or sculptures are utilized as learning and teaching tools, as well as a means to express and convey ideas and knowledge.

Other aspects are described infra.

### BRIEF DESCRIPTION OF THE DRAWINGS

FIG. 1 is a schematic representation showing one embodiment of a device that expresses a living system.

FIG. 2 is a schematic representation showing a close up view of a flower, photovoltaic cell, light emitter and adjustable rods.

FIG. 3 is a schematic representation showing a close up of a stylized disembodied person who is linked into a circuit and is controlled by external influences.

FIG. 4 is a schematic representation showing the support base 109 and deck 118 wherein the crumpled leaf 401 rests quietly on the deck after tearing itself loose from the chains.

FIG. 5 is a schematic representation showing a close up view of the movable unit or cart, close-ups of different components of the stand, a close up of the radial extension, support pillar and foundation plate, representative of a jet turbine engine.

FIG. 6 is a schematic representation of another embodiment of the invention.

FIG. 7 is a schematic representation of another embodiment of the invention.

### DETAILED DESCRIPTION

Embodiments of the invention comprise a device, electrochemical or otherwise, wherein the device and components thereof is an expression of living organism. Embodiments of the invention are directed to three dimensional, sculptural, mechanical devices that give the appearance that they can nurture and grow organic life forms, such as flowers, animals, reptiles, birds, humans and the like. The sculptures or devices comprise components to portray the appearance of independent and self-contained units which have the ability to travel. These components can resemble engines, motors, wheels and the like. In some embodiments, the sculptures or devices comprise a light source or emitter, such as, for example, LED lights. The devices can comprise electrical wires and plugs so as to power the device.

### DEFINITIONS

The terminology used herein is for the purpose of describing particular embodiments only and is not intended to be limiting of the invention. As used herein, the singular forms “a”, “an” and “the” are intended to include the plural forms as well, unless the context clearly indicates otherwise. Furthermore, to the extent that the terms “including”, “includes”, “having”, “has”, “with”, or variants thereof are used in either the detailed description and/or the claims, such terms are intended to be inclusive in a manner similar to the term “comprising.”

The term “about” or “approximately” means within an acceptable error range for the particular value as determined by one of ordinary skill in the art, which will depend in part on how the value is measured or determined, i.e., the limitations of the measurement system. For example, “about” can mean within 1 or more than 1 standard deviation, per the practice in the art.

Devices or Sculptures

In general embodiments, the process of creating the inventive devices or sculptures comprises, combining (usually but not restricted to) metals such as cast bronze, stainless steel and copper; then cutting, welding, bolting, pressing, gluing or casting (among other possible “joining” procedures) the elements together to form recognizable representations of living organic forms, such as flowers, along with mechanical electrical features (such as but not limited to pulleys, chains, gears, lights, pumps, conveyor belts, engines and wheels) that appear to be nurturing, supporting and/or transporting the organic form.

In general, the invention is directed to three dimensional sculptural mechanical devices that can nurture and grow organic life forms, such as flowers. In preferred embodiments, these devices are independent and self-contained and are constructed so that they give the appearance that they have the ability to travel. For example, the sculptural devices comprise components made to resemble engines, such as for example, a diesel engine and wheels; components resembling jet turbine engines that would allow them to fly, drive or otherwise travel from place to place. In some embodiments, the devices and components thereof are functional and/or comprise one or more functional units. The devices are constructed with realistic looking components, such as motors, pumps, conveyors, solar panels, jet turbines, pulleys, chains and cranes, and placed together in a rational, logical, systematic order. In some embodiments, the devices and/or components may or may not actually function except as a means of expression, they are constructed with realistic looking components, such as motors, pumps, conveyors, solar panels, jet turbines, pulleys, chains and cranes, and placed together in a rational, logical, systematic order that gives the appearance that these components actually work.

Thus, although the discussion herein discusses a wide variety of components, it should be understood that these components can be either functional or representative. For example, the organic life-forms (e.g., leaves or petals) are generally components that resemble or represent an organic life-form not actual organic life-forms. Similarly, the jet engines and diesel motors are generally components that resemble or represent such systems. In addition, solar panels, LEDs and wheels can be functional. Thus, to simplify the description of the devices described herein, the components of those devices are described are functional, it should be understood that the components described herein can be either functional or representative of functional systems.

The devices or sculptures are utilized as learning and teaching tools, as well as a means to express and convey ideas and knowledge. For example, these devices or sculptures can be used to teach how the environment can be affected by man; the limitless knowledge that man can attain and how or when or if man should use it. The sculptures or devices can be used to learn, for example, how man affects the environment, or the systems required to nurture a living organism. In addition, the devices or sculptures are a means for the artist or conveyor of a message to communicate a message to the observer. These messages can pertain to the artist's interpretation of the world, an expression of thought, a means to educate. The means to communicate can take a wide variety of forms, ranging from realism to cubism, from impressionism to abstract art, and everything in between. New and different messages and methods of expressing these messages would be always evolving. The utility of the devices are thus limited only by the imagination of the user.

In preferred embodiments, the sculptures are representative of an electrical/chemical/mechanical device capable of supporting, nurturing, and transporting an organic life-form, such as, for example, a flower, a human, a reptile, a bird and the like. In general, each device or sculpture is created using any one or more types of mediums. In some embodiments, the sculptures are created using metals, such as for example, bronze and stainless steel. In other embodiments, the medium is clay, wax, cement, plastics or the like. However, any type of medium or combination of mediums can be used, limited only by the artist's imagination.

In some examples, the devices are representative of an organic feature such as a plant, e.g. a flower, but may include animal, avian, insect, microbial, viral, amphibian, nucleic acids, organic compounds, parasitic, reptilian forms or combinations thereof.

In other examples, the devices comprise mechanical and/or electrical and/or chemical features which appear to nurture and protect the organic form.

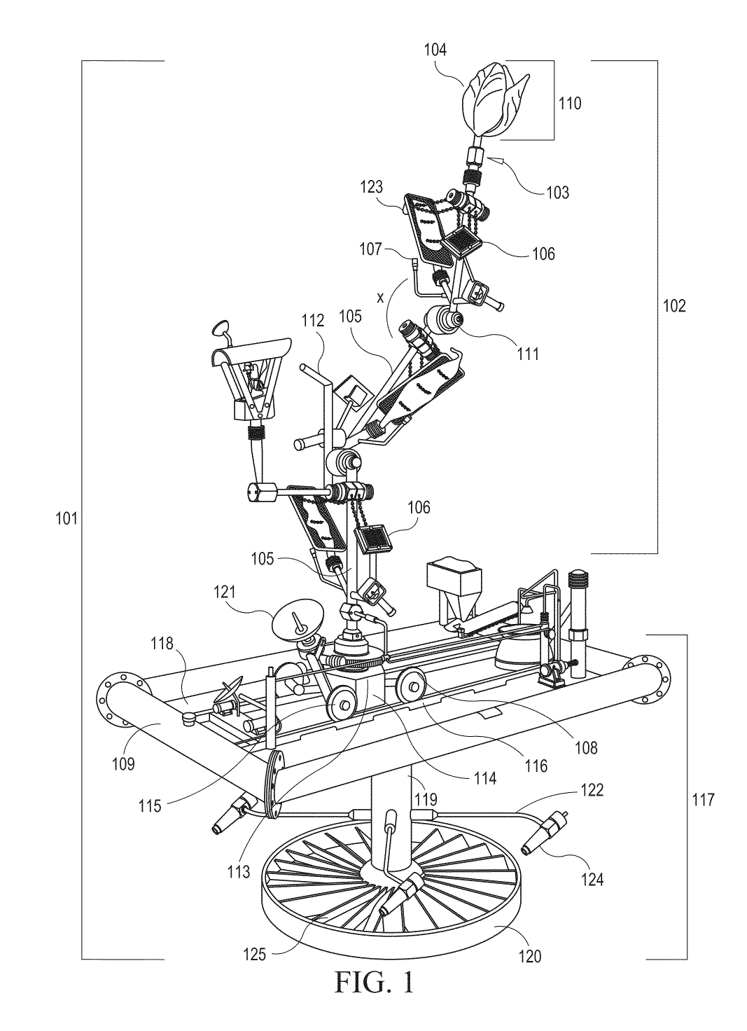

In yet other examples, the devices comprise elements that give the appearance that they have independent means of locomotion. For example, in FIG. 1, the stand 117 comprises a jet turbine as a base 120. This conveys the suggestion to the observer that the device or sculpture can fly.

In yet other examples, the devices or sculptures are created to provide the appearance or suggestion that they are self-contained units. These self-contained units can move from place-to-place and include all features necessary to nurture and protect the organic form. For example, a source of nutrients that is provided to the roots of a plant; a source of electromagnetic radiation that is provided proximate the leaves of the plant; and a controller that operates the self-contained unit.

In yet other examples, the devices or sculptures comprise one or more satellite dishes, antennas or any structure which convey the impression that although the sculptures are self-contained, they are receiving information from some an unknown source or sources.

As an illustrative example, not meant to be construed as limiting, FIGS. 1-5 show a flowering plant as the living system or organism expressed though the device. The use of this figure or flowering plant as the living organism or organic form is merely to provide illustration and is not meant to limit the device to these specific components, shape and form, nor to limit the expression of the living system chosen for expression via the device. Further, use of FIGS. 1-5 is for descriptive purposes only and is not meant to provide any limitations as to the device itself or the expression of the type of living organism. One of ordinary skill in the art can modify or manufacture a device to express any type of desired living system or living organism.

In one example, a device comprises a base; and an electromechanical representation of a life sustaining feature of a living system. The electromechanical representation can comprise a life sustaining feature. Depending on the representation the device is intended for, the life sustaining feature can differ. As an illustrative example, a flowering plant can be represented (see, for example, FIG. 1). The life sustaining features of a plant, include, among other things, roots, leaves, petals stamens, and stems. In some embodiments, a life sustaining feature is a leaf and the electromechanical representation comprises a photovoltaic cell, a leaf, a leaf support, and a light.

As shown in FIGS. 1-5, representative of an embodiment of a device, a device 101 comprises one or more components which correspond to parts of a living system, for example, the living system is a flowering plant 102. In this embodiment, the components comprise at least one base 103 for affixing petals 104; at least one rod 105 corresponding to a stem; at least one photovoltaic cell or panel 106; leaves 123; at least one light emitter 107, a movable or moving base unit 113; and, a stand 117.

In one embodiment, the petals 104 of the flower 110 are fixed or movable. The petals are affixed to a movable or immovable member of the base 103 which holds the petals. For example, the base 103 can comprise a pivoting member including, but not limited to, a hinge-like member or a ball-and-socket type member to allow for movement of the petals 104. The moving petals emulate the opening and closing of a flower. In some aspects, the petals are movable from left to right on a horizontal plane, up and down on a vertical plane, angular to an adjacent petal, or combinations thereof.

The petals 104 can be made from any material or combinations of materials that the user desires. In some aspects the petals 104 are opaque, clear, solid, meshed, or combinations thereof. The petals 104 can be any desired color or, if clear, any hue or shade desired by the user.

The petals 104 can be made from flexible, semi-flexible or rigid materials. The materials can comprise metal, alloys, plastics, glass, synthetic materials, natural materials, rubber, elastics or combinations thereof.

The stand 117 can include a support base 109 that supports the living system 102 (e.g., a flowering plant). The support base 109 can be any shape, size and manufactured by any desired material, so long as the support base supports the living system 102. The support base 109 can be made from a variety of materials, such as for example, metal, alloys, plastics, glass, synthetic materials, natural materials, or combinations thereof. In some embodiments, the support base comprises a tubular stainless steel frame.

The device 101 can include one or more rods 105. The rods 105 can be analogous to a stem structure. If desired, the one or more rods 105 can be adjustable in height and orientation. The rods 105 can be of similar or differing lengths with respect to each other. Each rod can comprise one or more components to rotate, retract or bend 111. The component 111 can be a hinge, a ball-and-socket joint or another pivot or rotation point. An example is shown in FIG. 1 wherein a rod is at an angle (X) with respect to an adjacent rod, wherein angle X is about 0° to about 180° with respect to an adjacent rod 105. In addition, the component 111 is fashioned to resemble an ionization chamber.

The rods 105 can be cylindrical having a hollow center or solid. The rods can be perforated, can have decorative etchings or marks and the like.

The different components of the device which are desired to be non-movable, can be attached to each other via bonding, gluing, nailing, pinning, screwing, sewing, stapling, welding or combinations thereof.

The device can include at least one photovoltaic cell 106. Each photovoltaic cell 106 can be independently movable or fixed. In those embodiments wherein the at least one photovoltaic cell 106 is movable, the rod 105 and photovoltaic cells 106 can be connected by a means to adjust the angle or orientation of the photovoltaic cells 106 with respect to the rod 105.

It is to be understood that the term “photovoltaic cell” also refers to a plurality of photovoltaic cells to form photovoltaic panels. As with other components of the device 101, the photovoltaic cell can be active or simply a representation of a photovoltaic cell.

The device can include at least one light emitter 107. The light emitter can be mounted to a flexible or rigid auxiliary rod 112 and the flexible auxiliary rod 112 can be affixed to a rod 105. The device can include both flexible and rigid auxiliary rods 112.

The light emitter 107 can be a light emitter including, but not limited to, a Light-Emitting Diode (LED), a halogen light emitter, a chemiluminescent light emitter, a fluorescent light emitter, a plant grow light, or combinations thereof. The light emitter 107 can be used as a source of light. For example, a concave or convex mirror which reflects natural sunlight or from any other source of light. The light emitted can be of any wavelength in the visible and/or invisible spectrum. The light emitter 107 can be powered by a photovoltaic cell 106 and can be arranged to provide light to a leaf 123 of the plant 102. Thus, although the sun could be the ultimate source of energy provided to the plant 102, the light emitter 107 would be the source of light to nurture and sustain the plant 102.

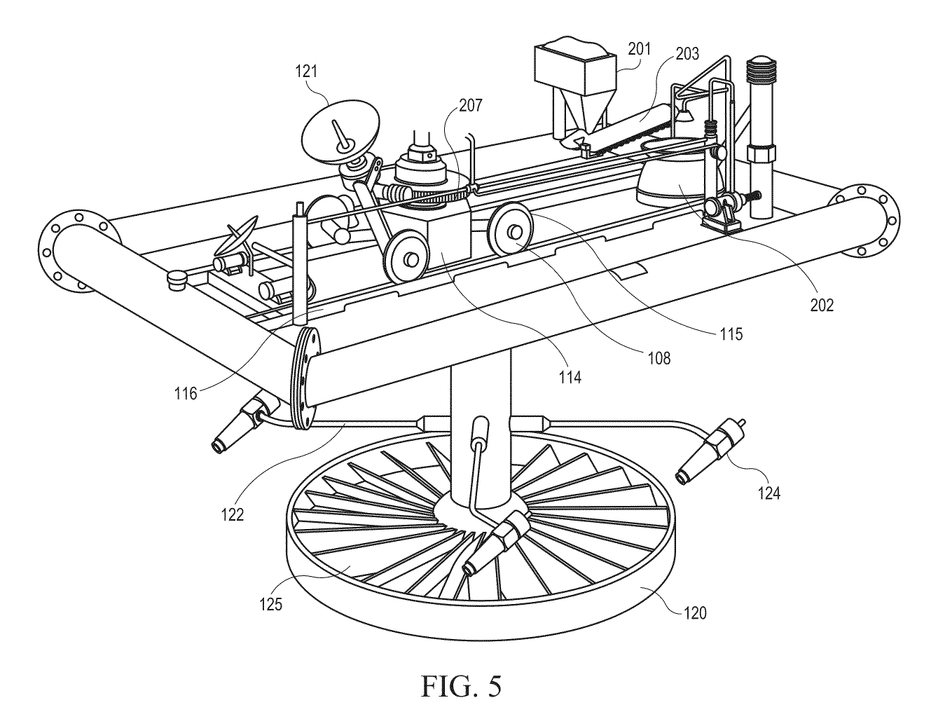

In a preferred embodiment, the rod 105 is affixed to a movable base unit or wheeled carrier 113, the movable base unit 113 comprising a central unit 114 attached to at least one wheel element 108. (See, for example, FIG. 5). The at least one wheel element 108 can comprise a groove 115 and the groove can be positioned on a track element 116. The track element 116 can comprise at least one track 116 which is dimensioned to fit the groove 115 on the at least one wheel element 108. The track element can be any shape or number of tracks. For example, the track element(s) can be a circular closed circuit, two parallel rods, circuits having straight and curved portions, or any combinations thereof.

The movable base unit or wheeled carrier 113 can be movable by mechanical means, physical means or combinations thereof. For example, the mechanical means can include a motor to rotate the at least one wheel element, a pulley system, a winding mechanism or combinations thereof.

In other embodiments, the weight and size of the movable base unit or wheeled carrier 113 is variable and balances against the weight of the adjustable rod and attachments thereto without tipping.

The device can also comprise a stand 117. The stand can include a representation, for example, of a means for locomotion or can be a complete vehicle. For example, a turbine engine 120, which creates the impression or embodies the ability of the sculpture or device to be able to move independently. In some embodiments, the stand 117 comprises a support base 109, the support base comprising a rectangular or square supporting surface or deck 118, at least one support pillar 119 and at least one foundation plate 120 which is created to resemble a turbine or jet engine such that the observer understands that the device or sculpture has the ability to travel, in this case, by flight. Preferably, the supporting surface or deck 118 is attached to the at least one support pillar 119 and the at least one support pillar is attached to the foundation plate 120.

In some embodiments, a support pillar 119 comprises at least one radial extension 122 perpendicular to the support pillar. In some embodiments, the at least one radial extension further comprises a decorative fixture 124, which gives the impression that the turbine engine 120 rotates and adds to the artists intent that the device or sculpture can move, powered by a turbine or jet engine. (See, for example, FIGS. 1, 5).

In preferred embodiments, the supporting surface or deck 118 comprises different elements that can be placed on the support base. These elements, for example, are a representation nutrients and water, providing energy for plant growth. These elements comprise the track element 116, the movable base unit 113, cosmetic 121 or other fixtures, e.g. satellite dish or antenna 121. Examples of cosmetic 121 or other fixtures 121 include, for example, a power source, photovoltaic cells or panels, antennas, satellite dishes, pulleys, chains, cranes, knobs, and the like.

The at least one foundation plate 120 can be shaped, dimensioned and weighted to support the device and to provide balance. Preferably, the at least one foundation plate 120 can be shaped in any desired shape or form. Examples include without limitation: a star shape, circular, oval, rectangular, square, semi-circular, triangular or combinations thereof. The foundation plate 120 can be fashioned to resemble a jet turbine engine comprising a solid base, a grid, vanes 124, or combinations thereof. The support base 109 can be manufactured so as to swivel about the pillar 119 or can be fixed.

The device 101 can be constructed from various materials and each component can, if desired, vary in the type of materials used for each component. Examples of materials used in the construction of the device, include without limitation: metals, alloys, plastics, rubber, silicones, polymers, glass, synthetic or natural material, graphite or any combinations thereof. In embodiments, the device or sculpture comprises cast bronze parts and metal shapes fabricated from metal sheets, bars and rods, such as, for example, stainless steel and aluminum.

As discussed above, the device can be designed to express any type of living organism from any of the plant and animal phyla. Examples also include animal and plant cells. The different components of the sculpture convey the artist's messages and purpose behind the sculptures or devices and will be described as such.

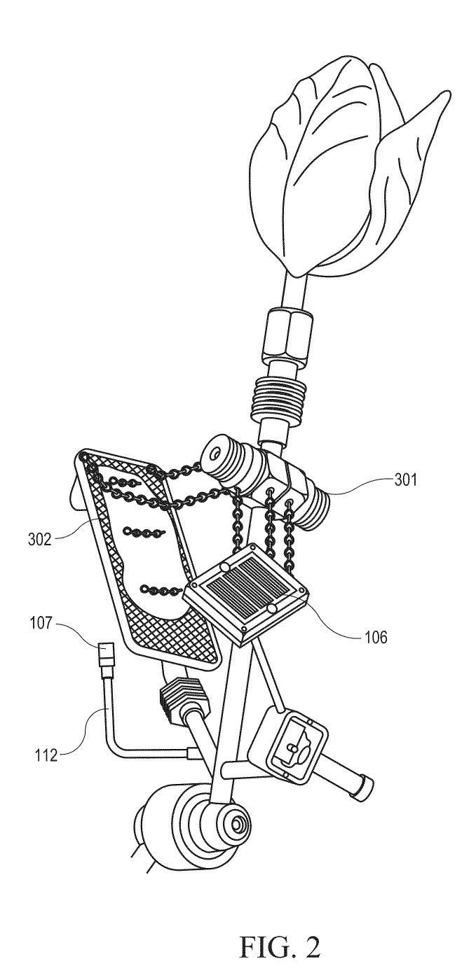

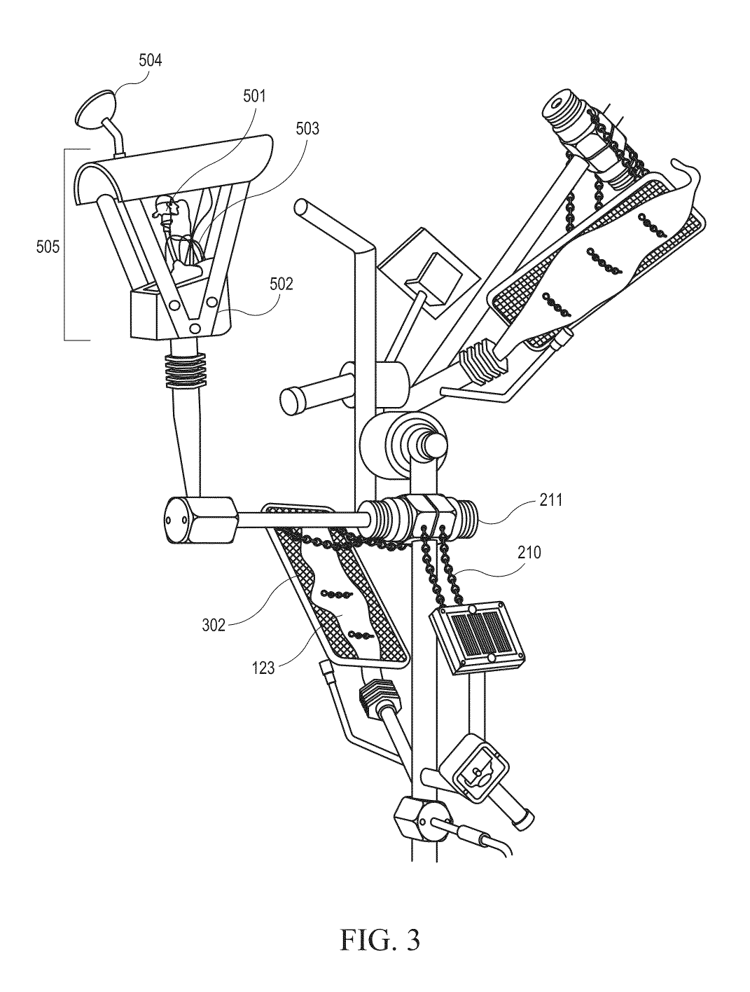

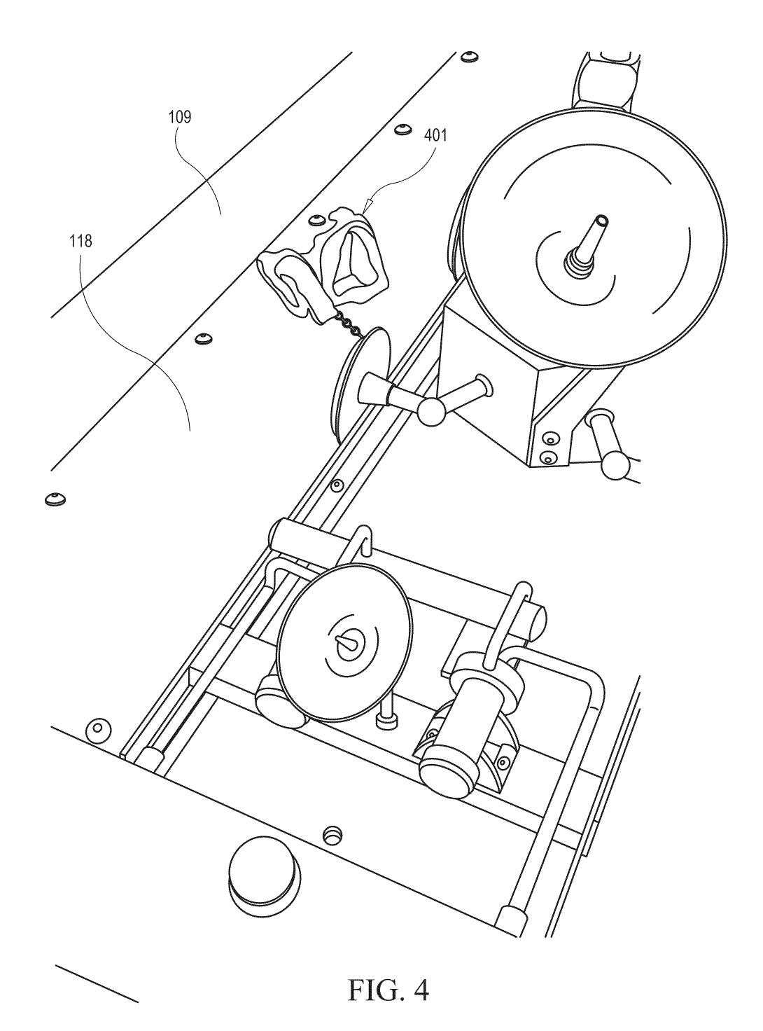

The invention is also drawn to a method of expression. The method can include displaying a sculpture 101 to an individual. The method can include a sculptor creating a sculpture 101 as described herein to express humanities disengaging trend away from nature. For example, the device 101 shown in FIGS. 1-5 speak to the present from the “not too distant future” about the disengagement of society from nature to the point where society attempts to replace and recreate nature using technology. In this embodiment, general, the sculpture or device 101 comprises the support base having a tubular stainless steel frame 109 holding a chemical charged liquid which is sprayed over a fertilized manure like mixture, that is then transferred from a holding tank 201 by conveyor belt 203 to the round enriching tank 202 (see, FIGS. 1 and 5). The resulting fermented green liquid settles to the bottom of the tank, and is pumped from the tank to the metal flower stem 105 and up to the flowering plant 102 itself. On the journey to the flower head 104, the tube 105 that carries the liquid is split off at the 3 flower leaves 123 to provide the necessary nutrients for the leaves 123 to grow. Turning to FIGS. 1 and 2, at the base of the flower head and the three leaves there is an ionized combustion chamber 111 and/or 301 where the liquid is heated and electrolyzed before being fed to the “living organisms.” There is a sense from the manner in which the growing leaves 123 are impaled and chained to the grid 302, that they are living against their will. This is further accentuated when the bottom leaf 401 shown in FIG. 4, crumbled to illustrate that it was somehow able to tear itself loose from the chains in a suicidal struggle to end its agony. In this embodiment, (see, FIG. 4) the remains of the crumpled leaf 401 rests quietly on the support surface or deck 118. The lights 107 shining on the leaves are used to promote photosynthesis. The chains 210 which connect the grids to the winches 211 on the stem are designed to control the angle of each grid, positioning each leaf to the best light and weather conditions that maximize growth potential (see, for example, FIG. 3). The wheeled carrier also appears to move, as does the stem at the bottom rotating gear 207, and at the mechanical ball joints, all to maximize growth potential from proper positioning. These moving mechanical parts are powered by solar cells 107 and create the impression that the device is guided by wireless transmitted instructions which are collected by the satellite dishes 121. The sculpture creates the impression that it would be conceivable and expected that most, if not all, of these instructions were coming from the “pilot house” 505 where the head of a man with no body except for a spine and hip bone 501 that sits in a large tub 502 of the same green liquid which is being pumped to the leaves and flower head. It could be postulated that this human oddity was likely a cryogenic volunteer (a procedure which gives more evidence of the disengagement from that which is spiritual and natural) who has been awakened from his death sleep only to labor forever as a pilot of the sculpture or device (termed herein as “NAF-ST100501”). It is certain, from the wires connecting his head and spine to the control panel, that he indeed is controlling the movements of the device or sculpture. It could be postulated that this cryogenic volunteer is in total control and perhaps even the author of this mechanical/living wonder, were it not for the satellite dish 504 on top of his “pilot house” 505, which gives evidence that a more powerful force is providing primary decisions. This unknown force becomes even more curious to an onlooker who observes the large jet turbine engine 120 at the base of the construction, complete with stabilizing jets 124. The thoughts and questions provoked by the sculpture or device is whether the entire machine, pilot and all, can lift up and flyaway to some other place on the planet, or perhaps some other place in the universe. On deeper reflection, the onlooker or observer would view this mechanical aberration with a more critical and responsible eye with the thought that in the near future on this planet humanity will, more than likely, be able to create a “NAFSTI00501”, or something similar to it and whether this should be done because humanity could do it.

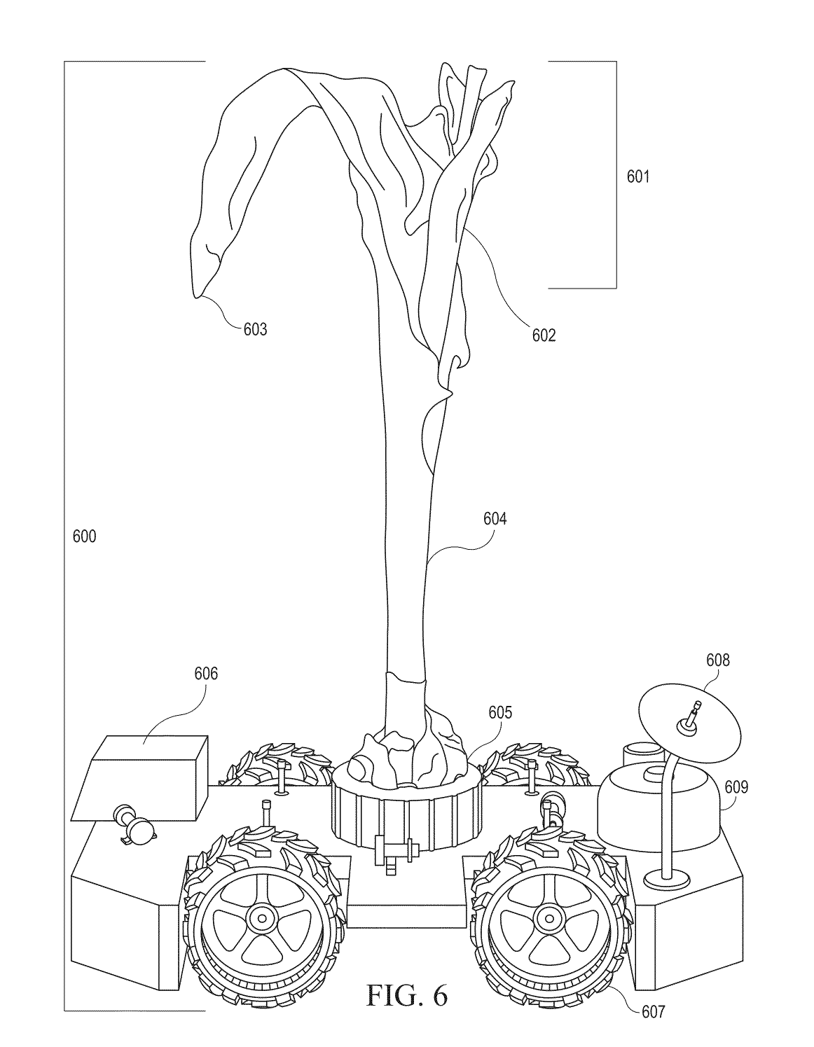

FIG. 6 represents another embodiment of a device or sculpture. In general embodiments, the device or sculpture comprises components to portray the appearance of independent and self-contained units which have the ability to travel. These components can resemble engines, motors, wheels and the like. In some embodiments, the sculptures or devices comprise a light source or emitter, such as, for example, LED lights. The devices can comprise electrical wires and plugs so as to power the device; elements or components which form recognizable images which look like living organic forms, such as flowers, along with mechanical electrical features (such as but not limited to pulleys, chains, gears, lights, pumps, conveyor belts, engines and wheels) that appears to be nurturing the organic form.

The device or sculpture 600 shown in FIG. 6 comprises a three dimensional sculptural mechanical device that can nurture and grow organic life forms, such as flowers 601. In preferred embodiments, the device is independent and self-contained and is constructed so that it gives the appearance that it has the ability to “travel”. For example, the sculptural device comprise components made to resemble engines 606, such as for example, a diesel engine and wheels 607. The sculpture or device also comprises a round holding tank or bell shaped component 609. In this device the organic life form comprises a flower 601, with a plurality of petals 602, at least one leaf 603, a stem or stalk 604 which sits on a mechanical component 605, resembling a cogwheel or any other such mechanical component. The sculpture or device further comprises a satellite dish 608 or any other component capable of receiving and/or sending information.

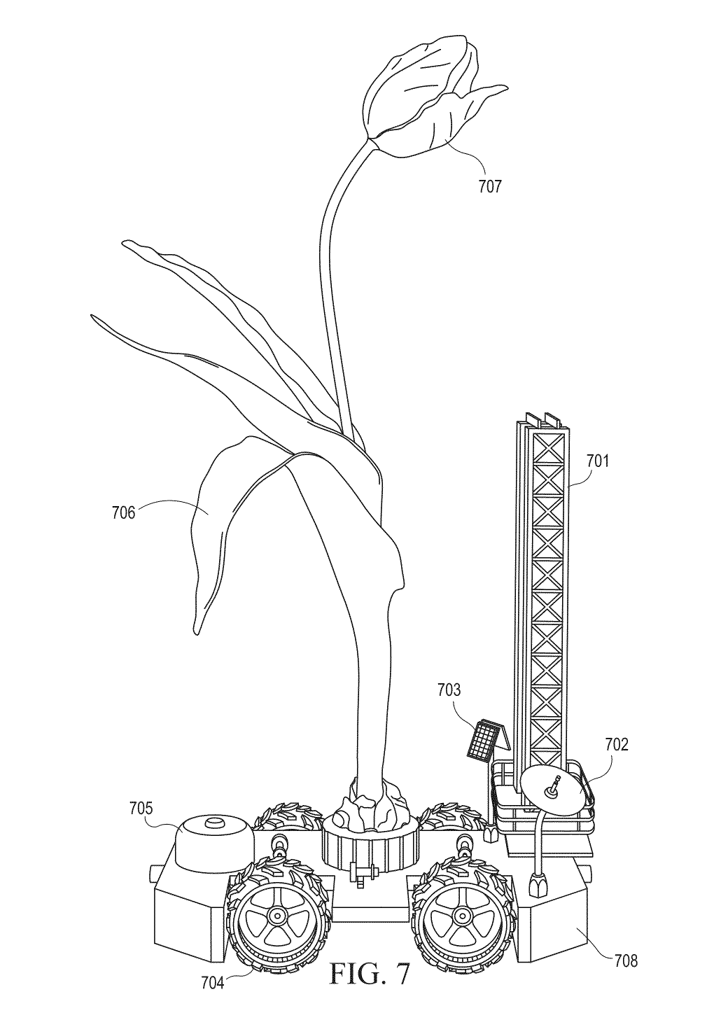

FIG. 7 is another embodiment of a sculpture or device. In this case the organic form is a flower 707 with leaves 706. The upward sweeping flower gives the appearance of growth as shown by one mechanical component 701, representative of, for example, a crane, ladder or elevator shaft 701 which is being built up to reach the growing flower. In this embodiment, the sculpture or device also comprises a satellite dish or antenna 702 to receive and/or transmit information, a power source 703 such as a solar panel, wheels 704 and an engine 705. These components convey the appearance that the entire unit 708 moves and is self-contained.

The invention has been described in detail with reference to preferred embodiments thereof. While various embodiments of the present invention have been described above, it should be understood that they have been presented by way of example only, and not limitation. It will be appreciated that those skilled in the art, upon consideration of this disclosure, may make modifications and improvements within the spirit and scope of the invention. Embodiments of the invention may be practiced without the theoretical aspects presented. Moreover, the theoretical aspects are presented with the understanding that Applicants do not seek to be bound by the theory presented.

The Abstract of the Disclosure is provided to allow the reader to quickly ascertain the nature of the technical disclosure. It is submitted with the understanding that it will not be used to interpret or limit the scope or meaning of the following claims.

What is claimed:

1. A device comprising:
a base;
a representation of an organic life-form;
components portraying independent and self-contained units; and
electrical/chemical/mechanical appearing components representative of systems capable of supporting, nurturing and/or transporting the representation of an organic life-form.

2. The device of claim 1, wherein the organic life-form comprises: plants, animals, reptiles, fish, birds, insects or combinations thereof.

3. The device according to claim 1, wherein the electrical/chemical/mechanical appearing components comprise photovoltaic cells, motors, pumps, conveyors, solar panels, jet turbines, satellite dishes, pulleys, wires, batteries, cogwheels, switches, chains, cranes, stabilizers, tanks, light sources, track elements, movable base units, a stand; or combinations thereof.

4. The device according to claim 1, wherein the device further comprises a nutrient source, a track, a cart and a trunk, wherein said track runs from said nutrient source to said trunk.

5. The device of claim 1, wherein said device is a sculpture.

6. The device of claim 2, wherein the organic life-form comprises one or more components selected from the group consisting of petals corresponding to a flower; at least one member for affixing petals; at least one rod corresponding to a stem; and, combinations thereof.

7. The device of claim 6, wherein the petals are movable on a horizontal plane, a vertical plane, angular to an adjacent petal, or combinations thereof.

8. The device of claim 6, wherein the petals comprise: metal, alloys, plastics, glass, synthetic materials, natural materials, or combinations thereof and the petals are opaque, clear, colored or combinations thereof.

9. The device of claim 6, wherein one or more rods are: adjustable in height and/or orientation; have similar or varying lengths; and, further comprise one or more means to rotate, retract or angle each rod at varying angles with respect to an adjacent rod.

10. The device of claim 3, wherein at least one photovoltaic cell is affixed to at least one rod and the photovoltaic panels further comprise a means to adjust the angle or orientation of the photovoltaic panel with respect to the rod.

11. The device of claim 3, wherein the light or light emitter is mounted to a flexible or inflexible auxiliary rod whereby each auxiliary rod is affixed to a movable rod.

12. The device of claim 3, wherein the light emitted is in the visible and/or invisible spectrum and the light or light emitter comprises: a Light-Emitting Diode (LED), a halogen light emitter, a chemiluminescent light emitter, a fluorescent light emitter, a plant grow light, or combinations thereof.

13. The device of claim 3, wherein the adjustable rod is affixed to a movable base unit, the movable base unit comprising a central unit attached to at least one wheel element and the at least one wheel element comprises a groove and the groove is positioned on a track element, the track element comprising at least one rod which is dimensioned to fit the groove on the at least one wheel element.

14. The device of claim 3, wherein the track element comprises a circular closed circuit, two parallel rods, circuits having straight and curved portions, or any combination thereof.

15. The device of claim 3, wherein the movable base unit is movable by mechanical means, physical means or combinations thereof, the mechanical means comprising a motor to rotate the at least one wheel element, a pulley system, a winding mechanism or combinations thereof.

16. The device of claim 3, wherein the stand comprises a support base, at least one support pillar and at least one foundation plate and the support base is attached to the at least one support pillar and the at least one support pillar is attached to the foundation plate.

17. The device of claim 16, wherein the support base comprises the electrical/chemical/mechanical components, track elements, the movable base unit, cosmetic fixtures, or combinations thereof.

18. The device of claim of claim 16, wherein the at least one support pillar comprises at least one radial extension perpendicular to the support pillar, the at least one radial extension further comprises a decorative fixture, the at least one foundation plate comprises a solid base, a grid, at least one vane, or combinations thereof, representative of a jet turbine engine.

19. The device of claim 16, wherein the support base swivels or is fixed to the support pillar.

20. A method of expression, comprising: exhibiting a sculpture according to claim 1.
